(19) United States
(12) Patent Application Publication
(10) Pub. No.: US 2016/0350604 A1
(43) Pub. Date: Dec. 1, 2016

(54) CYCLING COMPUTER WITH IMAGE PROCESSING DEVICE

(71) Applicant: Bion Inc., New Taipei City (TW)

(72) Inventor: Yu-Yu Chen, New Taipei City (TW)

(21) Appl. No.: 15/162,625

(22) Filed: May 24, 2016

(30) Foreign Application Priority Data
May 25, 2015 (TW) 104116599

(51) Int. Cl. G06K 9/00; G01P 15/00; H04N 5/247

(52) U.S. Cl. CPC G06K 9/00798; H04N 5/247; G01P 15/00

(57) ABSTRACT

A cycling computer with image processing device is provided for a bike and includes a monitor and a button. The cycling computer is designed to record traffic conditions and physiological signals of a rider. The traffic conditions and the physiological signals are digitalized into cycling data to be displayed on a monitor through operation of a button. A CCD device is mounted on the cycling computer for recording environmental images. An image processing unit is connected to the CCD device for receiving the environmental images captured by the CCD module. The environmental images are incorporated with the cycling data to form a plurality of object images. The object images are displayed on the monitor for versatile applications to the rider.

### BACKGROUND OF THE INVENTION

1. Field of the Invention

The present invention relates to a cycling computer for a bike, and in particular to a cycling computer with an image processing device adapted to be integrated with a bike and capable of providing versatile applications to rider.

2. The Related Arts

Cycling is a quite popular sport and convenient transport. The bike has environmentally friendly advantage, without need of fuel oil, making use of cycling increases sharply.

In order to provide the best riding experience to the rider, there are a considerable number of cycling computer capable of recording and displaying various information.

The conventional cycling computer is capable of recording traffic conditions such as mileage, speed, slope, altitude and traffic path. The cycling computer is also capable of detecting physiological signals such as heartbeat, temperature, or consumption of calories. These information serving as traffic conditions and physiological conditions after process and display for rider's references.

That is, the conventional cycling computer is only designed to focus on obtaining simple traffic information and physiological information during riding.

For example, in prior arts, Taiwan patent application No. 103140585 disclosed a personal exercise measurement system, and U.S. patent application Ser. No. 14/583,756 disclosed a personal exercise simulation system.

However, the conventional cycling computers do not provide functions of recording, processing, analyzing, and comparing surrounding environment images during riding.

Further, the conventional cycling computer does not provide functions of cooperating with exercise training device of an indoor fitness.

The conventional car recorder is designed to record images, without functions of measuring other information such as body activity, speed and physiological information.

For this reason, the conventional cycling computer still has room for improvement.

It is thus a challenge to the industry to overcome the above-discussed problems and issues.

### SUMMARY OF THE INVENTION

The primary object of the present invention is to provide a cycling computer with function of processing images, which incorporates advantages of conventional cycling computer of a bike and image processing technique to provide advanced record of information.

A further object of the present invention is to provide a cycling computer with function of processing images, which is capable of recording, photographing, processing images of topographies, objects and environments during riding.

A further object of the present invention is to provide a cycling computer with function of processing images, which is capable of integrating physiological signals of rider into the environmental images during riding for further applications.

Another object of the present invention is to provide a cycling computer with function of processing images, providing an image displaying function in addition to the original capabilities of the cycling computer.

To achieve the above objects, the cycling computer of the present invention includes a monitor and a button. The cycling computer is designed to record traffic conditions and physiological signals of a rider. The traffic conditions and the physiological signals are digitalized into cycling data to be displayed on a monitor through operation of a button. A CCD device is mounted on the cycling computer for recording environmental images. An image processing unit is connected to the CCD device for receiving the environmental images captured by the CCD module. The environmental images are incorporated with the cycling data to form a plurality of object images. The object images are displayed on the monitor for versatile applications to the rider.

In the above arrangement, a memory is connected to the image processing unit for storing the object images for providing other applications to the rider.

In the above arrangement, a GPS module is mounted in the cycling computer for detecting a geographic data of the bike. The geographic data is integrated into the object images and then real-time displayed on the monitor for providing navigation reference to the rider.

In the above arrangement, in addition to the display of the object images on the monitor, the cycling computer may couple to other external electronic devices. For example, the cycling computer 1 includes a RF wireless transmission device for transmitting real-time or recorded object images to the external electronic devices such as a personal computer, a smart phone or a television through a Wifi interface, a Bluetooth interface or an Infrared rays interface.

In the above arrangement, the cycling computer includes a wired transmission device for transmitting real-time or recorded object images to a personal computer, a smart phone or a television through a USB interface, a FireWire interface or a HDMI interface to display high-quality images.

In the above arrangement, when the bike incorporated with the cycling computer of this invention is located on street, the environment images around the bike may be captured by the smart phone or other portable electronic device, so that the rider can keep track of the bike to achieve anti-theft effect.

In addition, the cycling computer may include an acceleration sensor for detecting an acceleration data. The acceleration data is incorporated into the object images for providing valuable safety information to the rider of the bike.

In additional applications, the cycling computer of this invention may be connected with an exercise training device of an indoor fitness through a wireless transmission device or a wired transmission device for transmitting the object images to the exercise training device. The training resistance, the speed or other exercise status of the exercise training device can be adjusted to provide an exercise effect to the rider. By means of the cycling data recorded in the object image, it is possible to simulate a real movement to the rider, without need of riding bike outdoors.

Based on the image processing capability of the cycling computer of the present invention, the CCD device may include a rotatable shaft so that the CCD device is rotatable to face the rider to perform a self-taken photograph. Alternatively, the cycling computer may be provided with an inward CCD device arranged to face toward the rider to allow the rider to perform a self-taken photograph.

### BRIEF DESCRIPTION OF THE DRAWINGS

FIG. 1 is a functional circuit block diagram according to a first embodiment of the present invention;

FIG. 2 is a functional circuit block diagram according to a second embodiment of the present invention;

FIG. 3 is a perspective view of the present invention;

FIG. 4 is a top-side perspective view of the present invention;

FIG. 5 is a side-view showing that a cycling computer of the present invention is mounted to a bike;

FIG. 6 is a top-side perspective view showing a cycling computer of the present invention is provided with a shaft;

FIG. 7 is a top-side perspective view showing a cycling computer of the present invention is provided with a GPS Device; and

FIG. 8 is a top-side perspective view showing a cycling computer of the present invention is provided with an inward CCD device.

### DETAILED DESCRIPTION OF THE PREFERRED EMBODIMENTS

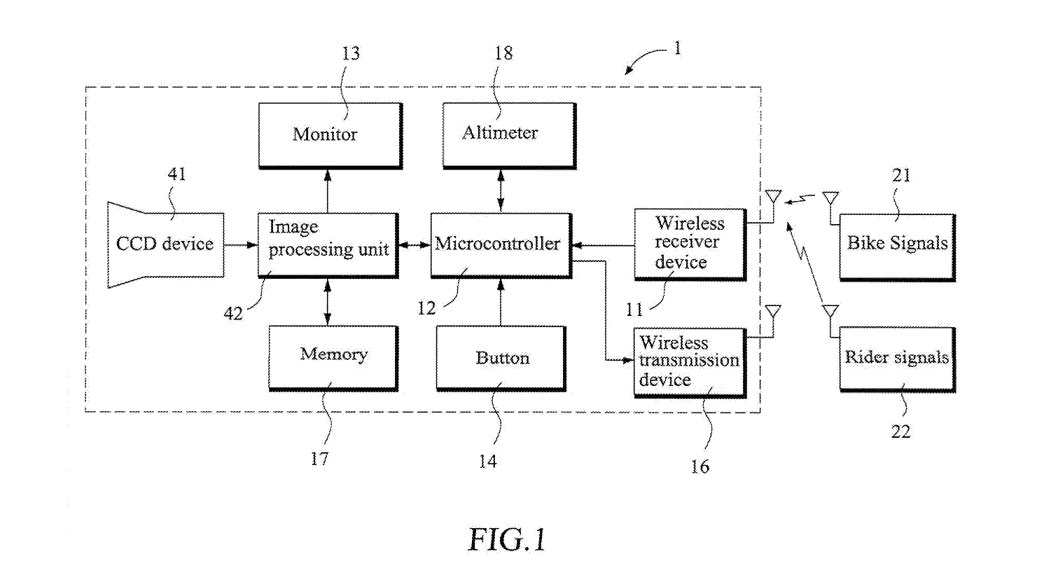

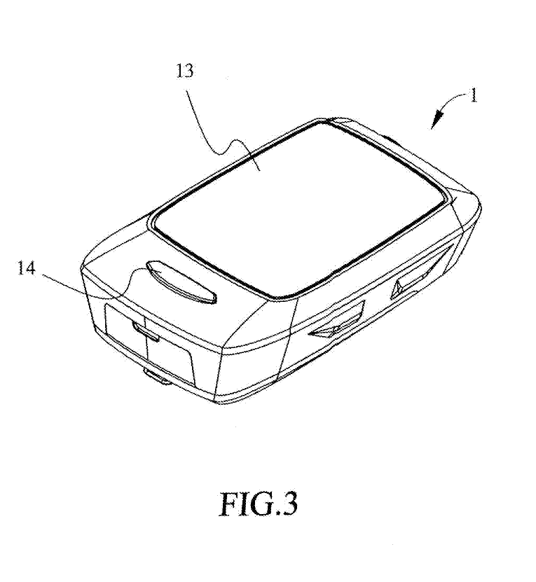

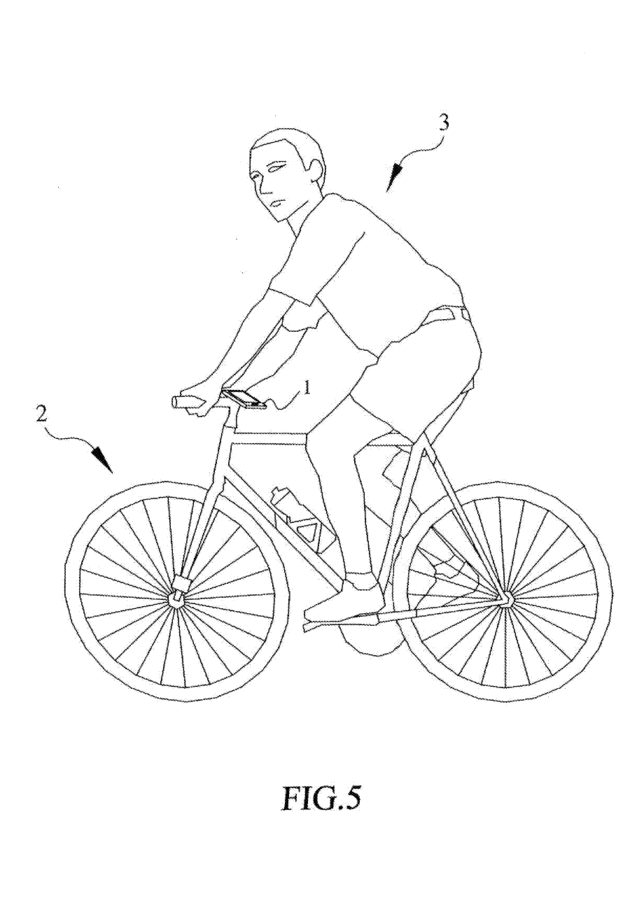

Referring to FIGS. 1, 3, 5 and 6, a cycling computer 1 with an image processing device according to a first embodiment of the present invention is mounted on a bike 2. The cycling computer 1 includes a wireless receiver device 11 for receiving Bike Signals 21 or rider signals 22. The Bike Signals 21 are obtained from at least one bike sensors mounted on the bike 2, including traffic conditions such as mileage or speed. The rider signals 22 are obtained from a rider, including physiological signals such as heartbeat, temperature or consumption of calories. The Bike Signals 21 and the rider signals 22 are transmitted to a microcontroller 12 via the wireless receiver device 11 for processing.

The cycling computer 1 is provided with a monitor 13 and a button 14. The traffic conditions recorded in the cycling computer 1 or the measured physiological signals of the rider are processed and digitalized into cycling data, and then the cycling data may be displayed on the monitor 13 through operation of the button 14. Of course, the cycling computer 1 may be provided with built-in sensor such as an altimeter 18 to obtain an altitude signal of the bike 2. The altitude signal may be added into the cycling data after processed by the microcontroller 12.

Base on the configuration above, the present invention further includes a CCD device 41 for recording environment images. The CCD device 41 is electrically connected to the image processing unit 42. The environmental images captured by the CCD device 41 are processed by the microcontroller 12 and then incorporated with the cycling data to form a plurality of object images to be displayed on the monitor 13.

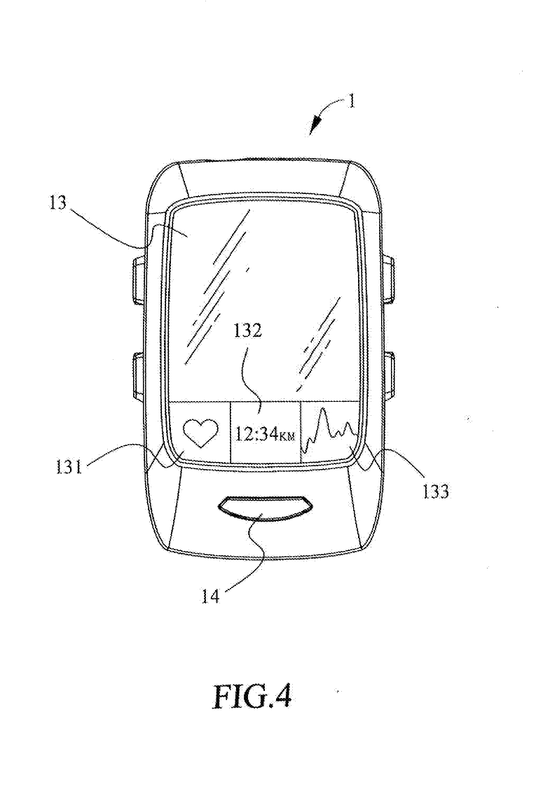

As shown in FIG. 4, the monitor 13 can display both the environmental images and the cycling data such as health images 131, mileage 132, altitude 133 and so on. The displayed images shown on the monitor 13 may be changed by means of microcontroller 12 through operation of the button 14.

A memory 17 may be connected to the image processing unit 42 for storing the object images.

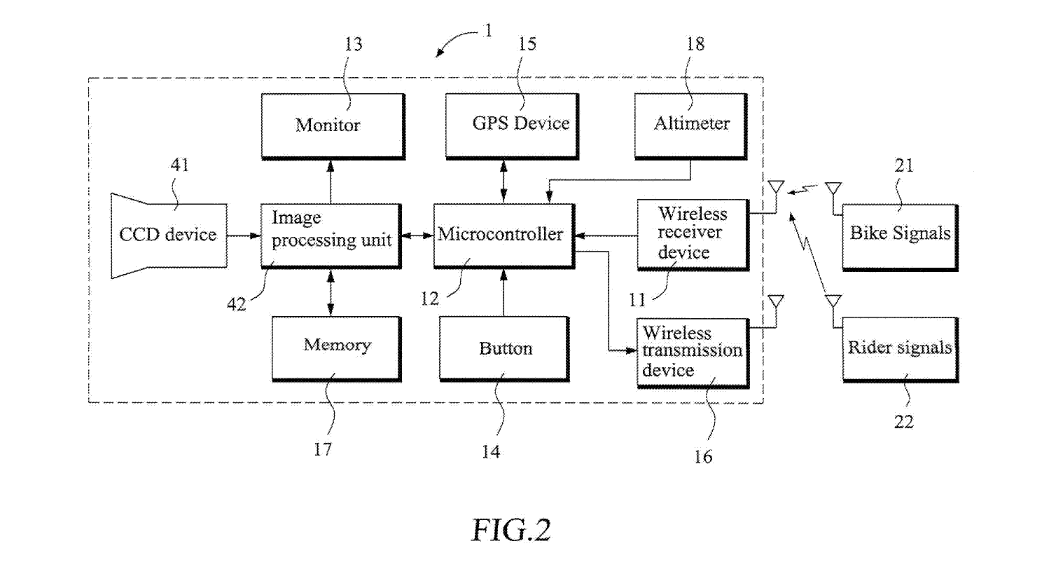

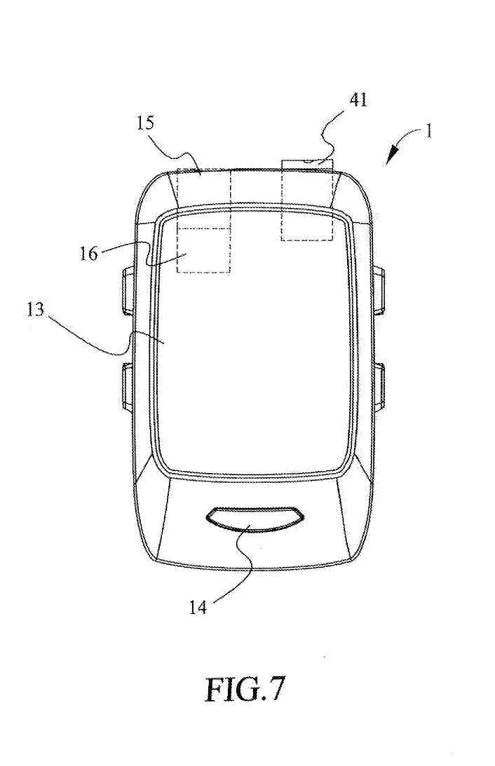

As shown in FIGS. 2 and 7, a GPS module 15 is mounted in the cycling computer 1 for detecting a geographic data of the bike 2. The geographic data may be integrated into the object images and then displayed on the monitor 13 for providing navigation reference to the rider 3.

Referring back to FIGS. 1 and 2, additional to the monitor 13 of the cycling computer 1 to show the object images, the cycling computer 1 may couple to other external electronic devices. For example, the cycling computer 1 includes a wireless transmission device 16 for transmitting real-time or recorded object images to the external electronic devices such as a personal computer, a smart phone or a television through a Wifi interface, a Bluetooth interface or an Infrared rays interface.

Alternately, the cycling computer 1 includes a wired transmission device for transmitting real-time or recorded object images to a personal computer, a smart phone or a television through a USB interface, a FireWire interface or a HDMI interface to display high-quality images.

When the bike 2 incorporated with the cycling computer 1 of this invention is located on street, the environment images around the bike 2 may be captured by the smart phone or other portable electronic device, so that the rider 3 can keep track of the bike 2 to achieve anti-theft effect.

In addition, the cycling computer 1 may include an acceleration sensor for detecting an acceleration data. The acceleration data may be incorporated into the object images for providing valuable safety information to the rider 3 of the bike 2.

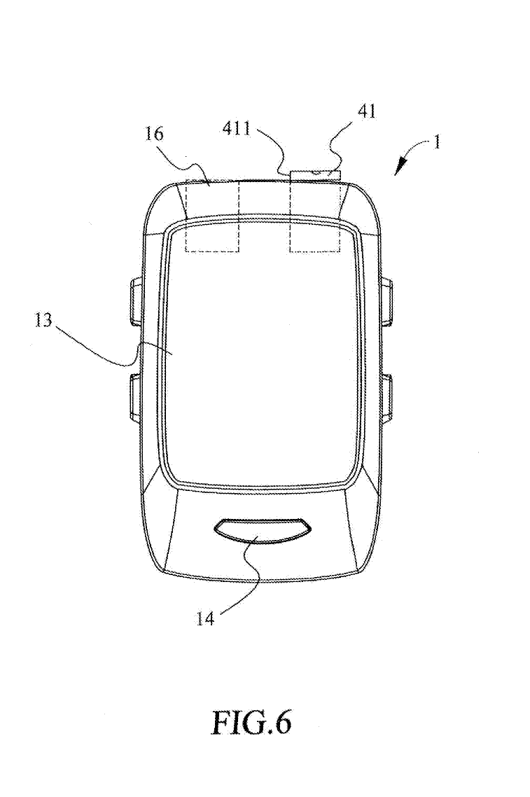

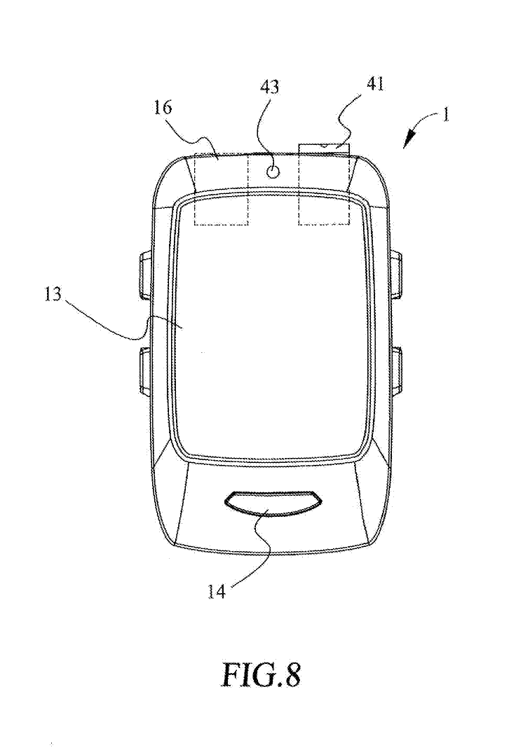

Referring to FIGS. 6 and 8, the CCD device 41 may include a rotatable shaft 411 so that the CCD device 43 is rotatable to face the rider 3 to perform a self-taken photograph. Alternatively, the cycling computer 1 may be provided with an inward CCD device 43 arranged to face toward the rider 3 to allow the rider 3 to perform a self-taken photograph.

In additional applications, the cycling computer of this invention may be connected with an exercise training device of an indoor fitness through a wireless transmission device or a wired transmission device for transmitting the object images to the exercise training device. The training resistance, the speed or other exercise status of the exercise training device can be adjusted to provide an exercise effect to the rider 3. By means of the cycling data recorded in the object image, it is possible to simulate a real movement to the rider 2, without need of riding bike 2 outdoors.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A cycling computer for a bike, provided with a monitor and a button, the cycling computer being adapted to record a plurality of traffic conditions and physiological signals of a rider, the traffic conditions and the physiological signals being digitalized into cycling data to be displayed on the monitor through operation of the button, characterized in that the cycling computer comprises:
a CCD device mounted on the cycling computer for recording a plurality of environmental images; and
an image processing unit mounted in the cycling computer and electrically connected to the CCD device for receiving the plurality of environmental images captured by the CCD module;
wherein the environmental images are incorporated with the cycling data to form a plurality of object images, and then the plurality of object images are displayed on the monitor.

2. The cycling computer as claimed in claim 1, further comprising a memory mounted in the cycling computer and connected to the image processing unit for storing the object images, the traffic conditions and the physiological signals, wherein the traffic conditions include one of a mileage, a speed, slope, an altitude and a traffic path, and the physiological signals includes one of a heartbeat, a temperature and a consumption of calories.

3. The cycling computer as claimed in claim 1, further comprising a GPS module mounted in the cycling computer and connected to the image processing unit for detecting a geographic data of the bike, the geographic data being integrated into the object images.

4. The cycling computer as claimed in claim 1, wherein the cycling computer further comprises at least one sensor for measuring one of a speed, a turned speed, and a physiological signal.

5. The cycling computer as claimed in claim 1, wherein the cycling computer further comprises a wireless transmission device connected to the image processing unit for transmitting the real-time or recorded object images to one of a personal computer, a smart phone and a television through one of a Wifi interface, a Bluetooth interface and an Infrared rays interface.

6. The cycling computer as claimed in claim 1, wherein the cycling computer further comprises a wired transmission device connected to the image processing unit for transmitting the real-time or recorded object images to one of a personal computer, a smart phone and a television through one of a USB interface, a FireWire interface and a HDMI interface.

7. The cycling computer as claimed in claim 1, wherein the cycling computer is connected with an exercise training device of an indoor fitness through one of a wireless transmission device and a wired transmission device for transmitting the object images to the exercise training device, so that the exercise training device controls one of a training resistance, a speed and a training information by using the cycling data recorded in the object image to simulate a real movement.

8. The cycling computer as claimed in claim 1, wherein the cycling computer further comprises an acceleration sensor for detecting an acceleration data, the acceleration data being incorporated into the object images.

9. The cycling computer as claimed in claim 1, wherein the CCD device is provided with a rotatable shaft so that the CCD device is rotatable to face the rider to perform a self-taken photograph.

10. The cycling computer as claimed in claim 1, wherein the cycling computer is provided with an inward CCD device arranged to face toward the rider to allow the rider to perform a self-taken photograph.
